(19) United States
(12) Patent Application Publication
(10) Pub. No.: US 2015/0222847 A1
(43) Pub. Date: Aug. 6, 2015

(54) APPARATUS AND METHOD FOR PROCESSING A VERTICAL BLANKING INTERVAL SIGNAL

(71) Applicant: MEDIATEK INC., Hsinchu (TW)

(72) Inventors: Ting-Hsun WEI, Tainan Hsien (TW); Hua WU, Jhubei City (TW)

(21) Appl. No.: 14/689,516

(22) Filed: Apr. 17, 2015

Related U.S. Application Data
(63) Continuation of application No. 12/130,207, filed on May 30, 2008.

(51) Int. Cl. H04N 7/088; H04N 5/265

(52) U.S. Cl. CPC H04N 7/0881; H04N 5/265

(57) ABSTRACT

Apparatus and method for processing a vertical blanking interval (VBI) signal and video signal are provided. An exemplary apparatus comprises a VBI decoder, a mixer, and a TV encoder. The VBI decoder is configured to receive and decode the VBI signal to generate a decoded VBI signal. The mixer is configured to mix the video signal and decoded VBI signal to generate a mixed signal. The TV encoder is configured to encode the mixed signal to generate a first TV compatible signal for TV display. After receiving the first TV compatible signal, the TV not equipped with a VBI decoder can display the contents of the video signal and VBI signal.

### CROSS-REFERENCES TO RELATED APPLICATIONS

The present application is a Continuation Application of U.S. patent application Ser. No. 12/130,207 filed on May 30, 2008, which is incorporated herein by reference.

### BACKGROUND OF THE INVENTION

1. Field of the Invention

The present invention relates to vertical blanking interval (VBI) signal processing for TV display.

2. Descriptions of the Related Art

TV screens on the market can be cathode-ray tube TVs (CRT-TVs), rear projection TVs (RPTVs), or flat panel TVs (LCDs or plasmas). TVs presents TV programs in a number of ways, for example, some TVs display extra information, such as vertical blanking interval (VBI) data, along with the TV programs.

VBI data is raw data carried on specific lines by a TV encoder. Specifically, the specific lines carrying VBI data correspond to the time interval between the end of either the last line of one TV frame or field of a raster display, and the beginning of the next TV frame of field. The VBI data may be used to carry digital data in analog TV systems, examples of the VBI data include various test signals, time codes, closed captioning, teletext, gemstar, subtitle, etc.

A conventional apparatus 1 for processing a VBI signal 10 is depicted in FIG. 1. The apparatus 1 comprises a TV encoder 11. The TV encoder 11 is mainly configured to receive a video signal 12 and encode into a first TV compatible signal 13. A TV (not shown) receives the first TV compatible signal 13 and displays the video carried therein. To display the VBI data carried by the VBI signal 10, the TV encoder 11 is further configured to receive the VBI signal 10 and encode it as a second TV compatible signal 14. The TV receives the second TV compatible signal 14 and displays the content of the VBI signal 10. To show the VBI data, a VBI decoder in the TV decodes the second TV compatible signal 14 so that the VBI data carried by the VBI signal 10 can be displayed. However, not all TVs on the market are equipped with VBI decoders, such as the CRT-TV.

### SUMMARY OF THE INVENTION

An apparatus for processing a vertical blanking interval (VBI) signal and a video signal comprises a VBI decoder, a mixer, and a TV encoder. The VBI decoder receives and decodes the VBI signal to generate a decoded VBI signal. The mixer receives and mixes the video signal and the decoded VBI signal to generate a mixed signal. The TV encoder encodes the mixed signal to generate a first TV compatible signal and inserts the VBI signal into the video signal to generate a second TV compatible signal. The apparatus is design with a function to select one of first TV compatible signal and second TV compatible signal for TV display.

A method for processing a VBI signal and a video signal is disclosed. The method comprises the following steps of: receiving the VBI signal and the video signal, decoding the VBI signal to generate a decoded VBI signal, mixing the video signal and the decoded VBI signal to generate a mixed signal, and encoding the mixed signal to generate a first TV compatible signal for TV display.

A TV receives a TV compatible signal from the apparatus to display the content of the VBI signal and video signal. Since the TV compatible signal comprises both the content of the VBI signal and video signal, a VBI decoder in the TV is no longer necessary.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 shows a schematic diagram of the conventional apparatus for processing a VBI signal;

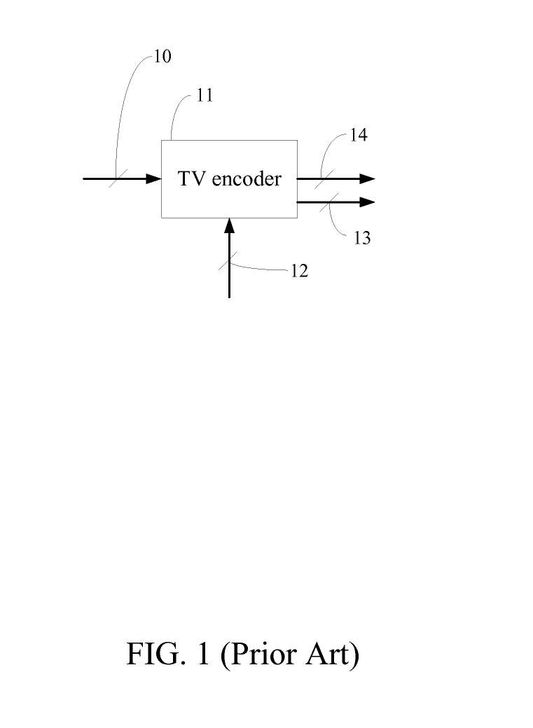

FIG. 2 shows a schematic diagram of a first embodiment of the present invention;

FIG. 3 shows a schematic diagram of another example of the first embodiment of the present invention;

FIG. 4 shows a schematic diagram of a second embodiment of the present invention;

FIG. 5 shows a schematic diagram of another example of the second embodiment of the present invention;

FIG. 6A shows a part of a flow chart of a third embodiment of the present invention; and

FIG. 6B shows another part of the flow chart of the third embodiment of the present invention.

### DESCRIPTION OF THE PREFERRED EMBODIMENT

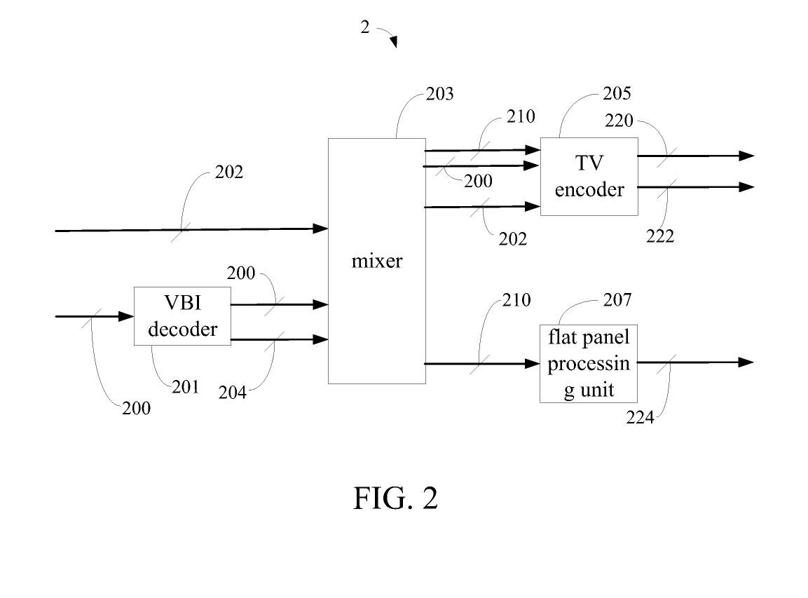

FIG. 2 shows a schematic diagram of a first embodiment of the present invention, which is an apparatus 2 for processing a VBI signal 200 and a video signal 202. The apparatus 2 comprises a VBI decoder 201, a mixer 203, a TV encoder 205 and a flat panel process unit 207. The VBI decoder 201 is configured to receive and decode the VBI signal 200 to generate a decoded VBI signal 204, wherein the source of the VBI signal 200 can be a CD, an antenna, and so on. The decoded VBI signal 204 comprises the content of the VBI raw data carried by the VBI signal 200.

More particularly, the VBI raw data carried by the VBI signal 200 are compressed, and the VBI decoder 201 decompresses the VBI raw data carried by the VBI signal 200. The VBI decoder 201 retrieves the content of the VBI raw data, wherein the content may comprise images, captions, and so on. Finally, the VBI decoder 201 generates the decoded VBI signal 204 according to the retrieved content. The mixer 203 is configured to receive the decoded VBI signal 204 and a video signal 202 and generate a mixed signal 210. By doing so, the mixed signal 210 comprises the content of the decoded VBI signal 204 and video signal 202.

After generating the mixed signal 210, the TV encoder 205 is configured to receive and encode the mixed signal 210 to generate a first TV compatible signal 220. Herein, the first TV compatible signal 220 is an analog signal for an analog TV and is particularly suitable for a TV not equipped with a VBI decoder. In this embodiment, the TV encoder 205 is capable of receiving the VBI signal 200 and the video signal 202 and inserting the VBI signal 200 into the video signal 202 to generate a second TV compatible signal 222. In this embodiment, the VBI signal 200 can bypass the VBI decoder 201 and the mixer 203 and transmit to the TV encoder 205, and the video signal 202 can bypass the mixer 203 and transmit to the TV encoder 205, to generate the second TV compatible signal 222. The first and second TV compatible signals 220 and 222 can be transmitted to a TV display via the same I/O, and for example, when connecting to a TV display without the capability of VBI decoding, the apparatus 2 outputs the first TV compatible signal 220, otherwise the second TV compatible signal 222. The apparatus 2 can also outputs the first TV compatible signal 220 to a TV display capable of VBI decoding, however, the VBI decoding function has to be disabled.

In addition, the flat panel process unit 207 is configured to receive the mixed signal 210 and process it to generate a flat panel compatible signal 224 for a flat panel TV. In other words, the signals output from the apparatus 2 are compatible with TVs without an equipped VBI decoder, TVs equipped with a VBI decoder, or flat panel TVs. It should be noted that, the flat panel process unit 207 is optional and can be omitted in some other embodiments.

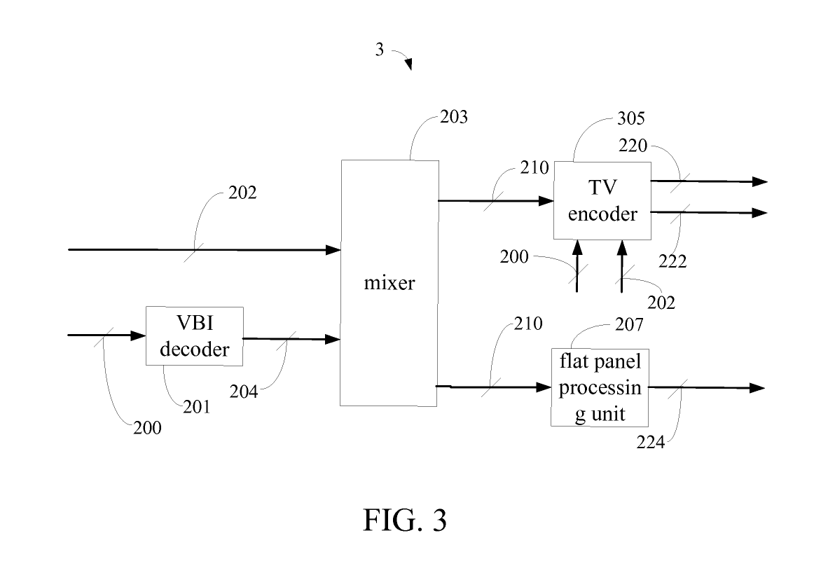

FIG. 3 shows a schematic diagram of another example of this embodiment of the present invention, which is an apparatus 3 for processing a VBI signal 200 and a video signal 202. The apparatus 3 comprises a VBI decoder 201, a mixer 203, a TV encoder 305, and a flat panel process unit 207. The similarities between the apparatus 2 and the apparatus 3 are not described again and only the differences between them are described. The TV encoder 305 is configured to receive the VBI signal 200 and the video signal 202. Instead of the VBI signal 200 and the video signal 202 respectively bypassing the VBI decoder 201 and/or the mixer 203, the TV encoder 305 can retrieve the VBI signal 200 and the video signal 202 from elsewhere.

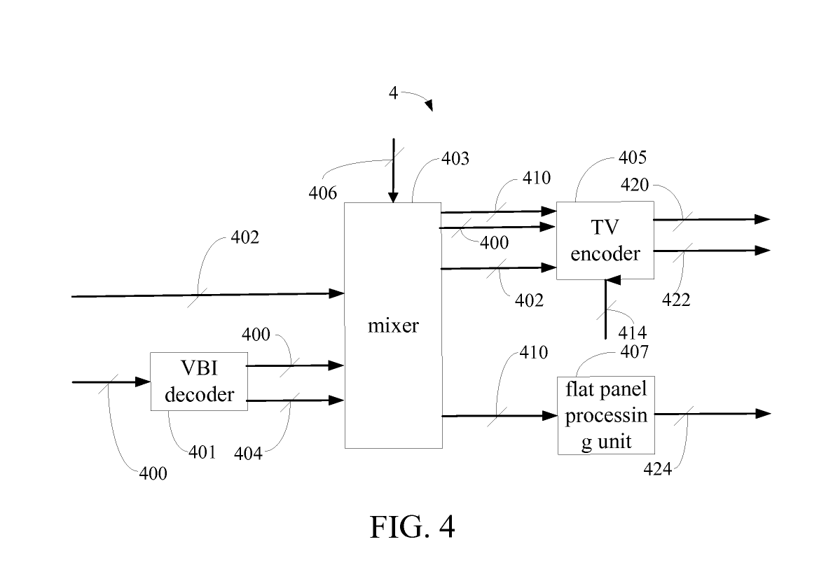

FIG. 4 shows a schematic diagram of a second embodiment of the present invention, which is an apparatus 4 for processing a VBI signal 400 and a video signal 402. The apparatus 4 comprises a VBI decoder 401, a mixer 403, a TV encoder 405, and a flat panel process unit 407. The VBI decoder 401 is configured to receive and decode the VBI signal 400 to generate a decoded VBI signal 404, wherein the decoded VBI signal 404 comprises the content of the VBI data carried by the VBI signal 400.

Not all TVs on the market have built-in VBI decoders. In the second embodiment, a status (e.g. ON or OFF) of the mixer 403 may depend on whether the TV has a build-in VBI decoder or not. That is, if the TV has a build-in VBI decoder, the status of the mixer 403 can either be ON or OFF. On the other hand, if the TV does not have a build-in VBI decoder, the status of the mixer 403 must always be ON.

First, it is assumed that the TV is not equipped with the VBI decoder, and the status of the mixer 403 is ON. The mixer 403 is configured to receive the decoded VBI signal 404 from the VBI decoder 401 and the video signal 402. Since the mixer 403 stays at the ON status, it blends the video signal 402 and the decoded VBI signal 404 to generate a mixed signal 410. By doing so, the mixed signal 410 comprises the content of the decoded VBI signal 404 and video signal 402. Particularly, the ON status of the mixer 403 is controlled by a first control signal 406. The first control signal 406 is either automatically fed back from the TV processor or manually input by users. As mentioned above, the mixer 403 generates a mixed signal 410 if the mixer 403 stays ON.

Since the mixer 403 stays ON, the TV encoder 405 receives and encodes the mixed signal 410 to generate a first TV compatible signal 420. In an embodiment, the first TV compatible signal 420 is an analog signal for an analog TV.

The mixer may be turned off when the TV encoder 405 is capable of inserting VBI raw data 400 to the video signal 402 (e.g. the TV encoder is equipped with a VBI decoder), in an embodiment of the apparatus 4, when the first control signal 406 turns the mixer off, the video signal 402 bypasses the mixer and the VBI signal 400 bypasses the VBI decoder 401 and the mixer 403, and the TV encoder 405 inserts the VBI signal 400 to the video signal 402 to generate a second TV compatible signal 422.

The TV encoder 405 is further configured to receive a second control signal 414, in response to the second control signal 414, select one of the first TV compatible signal 420 and the second TV compatible signal 422 as an output. The second control signal 414 can be generated depending on information of the connected TV display or the status of the mixer 403, or it can be set manually. In an example, the second control signal 414 is configured to select the first TV compatible signal 420 or the second TV compatible signal 422 as an output, depending on whether the TV comprises a VBI decoder or not, and in another example, the second control signal 414 depends on the first control signal 406.

Similar to the embodiment of FIG. 2, the flat panel process unit 407 is configured to process the mixed signal 410 to generate a flat panel compatible signal 424 suitable for a flat panel TV.

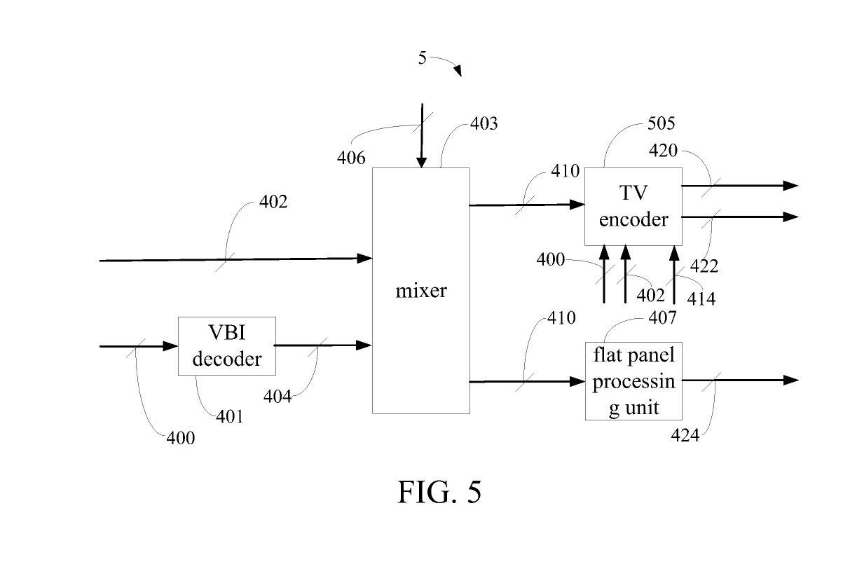

Please refer to FIG. 5, which is a schematic diagram of another example of this embodiment. FIG. 5 shows an apparatus 5 comprising a VBI decoder 401, a mixer 403, a TV encoder 505, and a flat panel process unit 407. The TV encoder 505 is configured to receive the VBI signal 400 and the video signal 402 from somewhere else instead of bypassing from the mixer 403. It should be noted that the control signals in the apparatus 4 and 5 can be selectively adopted according to the practice, which means not all the control signals are needed.

According to the above descriptions, the apparatus blends VBI and video signals to generate a mixed signal and encode the mixed signal to generate a TV compatible signal which can be directly displayed by TVs. Consequently, an analog TV or a flat panel TV can display the contents of a VBI signal, regardless of whether the analog TV or flat panel TV supports VBI decoders.

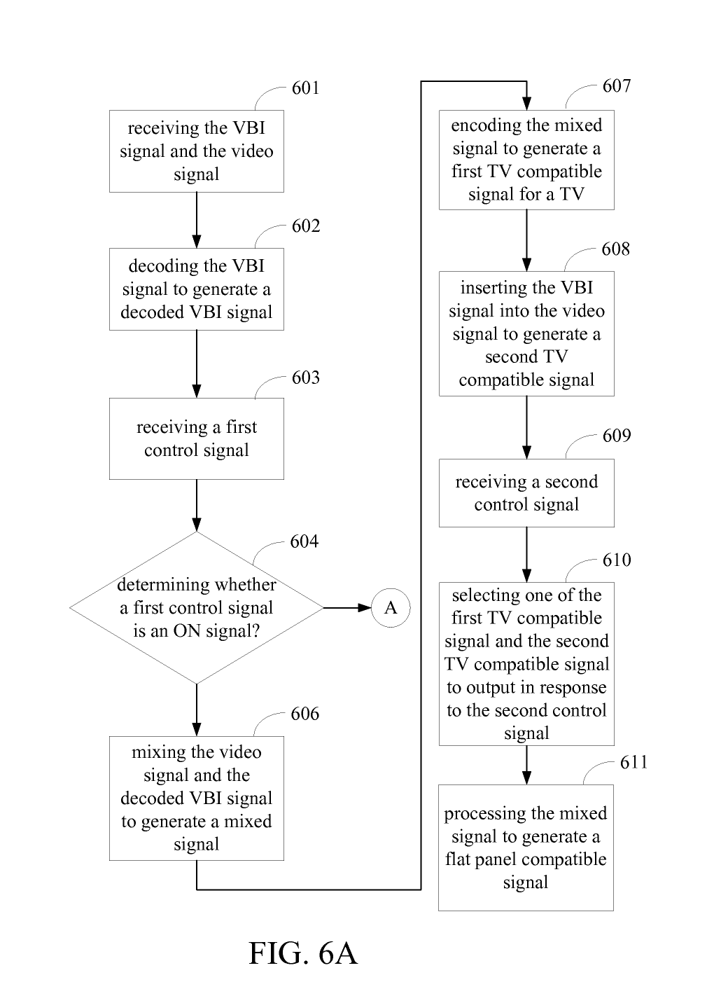

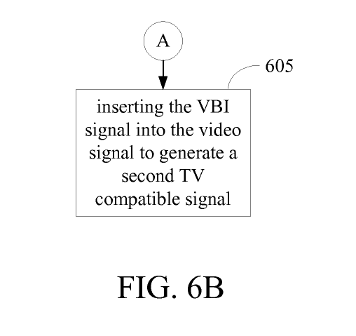

A third embodiment of the present invention is shown in FIGS. 6A and 6B, which are the flowcharts of a method for processing a VBI signal and a video signal. First, please refer to FIG. 6A, step 601 receives the VBI signal and the video signal. Step 602 decodes the VBI signal to generate a decoded VBI signal. Particularly, step 602 retrieves the content of the VBI signal and decodes the VBI signal in a way so that the decoded VBI signal comprises the retrieved content. Step 603 receives a first control signal. The first control signal may be automatically fed back from the TV or manually input from users. Step 604 determines whether the first control signal is an ON signal. If the first control signal is not ON signal, please refer to FIG. 6B, step 605 is executed to insert the VBI signal into the video signal to generate a second TV compatible signal which can be displayed by a TV equipped with a VBI decoder. Please refer back to FIG. 6A, step 606 blends the video and decoded VBI signals to generate a mixed signal if the first control signal is ON signal, wherein the mixed signal comprises the content of the video signal and the decoded VBI signal.

Step 607 encodes the mixed signal to generate a first TV compatible signal, which is suitable for any TV, either equipped or not equipped with the VBI decoder. Step 609 receives a second control signal. Step 610 selects one of the first TV compatible signal and the second TV compatible signal to output in response to the second control signal. For example, the second control signal makes the selection depending on whether a TV display comprises a VBI decoder. The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for processing a vertical blanking interval (VBI) signal and a video signal to output to a TV, the apparatus comprising:
a VBI decoder for receiving and decoding the VBI signal to generate a decoded VBI signal;
a mixer for receiving and mixing the video signal and the decoded VBI signal to generate a mixed signal; and
a television (TV) encoder for generating a first TV compatible signal by encoding the mixed signal comprising the video signal and the decoded VBI; and generating a second TV compatible signal by inserting the VBI signal into the video signal.

2. The apparatus according to claim 1, wherein when the mixer is in an ON status, the mixer generates the mixed signal by mixing the video signal and the decoded VBI signal.

3. The apparatus according to claim 2, wherein the ON status of the mixer is controlled by a first control signal.

4. The apparatus according to claim 3, wherein the first control signal is fed back automatically or inputted manually.

5. The apparatus according to claim 3, wherein the TV encoder further receives the VBI signal and the video signal.

6. The apparatus according to claim 5, wherein the TV encoder generates the second TV compatible signal when the first control signal disables the ON status of the mixer, and the apparatus is configured to output the second TV compatible signal to the TV.

7. The apparatus according to claim 5, wherein the TV encoder generates the second TV compatible signal in response to receipt of a second control signal.

8. The apparatus according to claim 1, further comprising a flat panel process unit for receiving and processing the mixed signal to generate a flat panel compatible signal.

9. A method for processing a VBI signal and a video signal, comprising:
receiving the VBI signal and the video signal;
decoding the VBI signal to generate a decoded VBI signal;
mixing the video signal and the decoded VBI signal to generate a mixed signal;
generating a first TV compatible signal by encoding the mixed signal comprising the video signal and the decoded VBI signal;
generating a second TV compatible signal by inserting the VBI signal into the video signal; and
selecting one of the first TV compatible signal and the second TV compatible signal for output to a TV.

10. The method according to claim 9, further comprising:
receiving a first control signal; and
determining whether the first control signal is an ON signal.

11. The method according to claim 9, further comprising:
receiving a second control signal; and
in response to receipt of the second control signal, selecting one of the first TV compatible signal and the second TV compatible signal for output.

12. The method according to claim 9, further comprising processing the mixed signal to generate a flat panel compatible signal.
